(19) United States
(12) Patent Application Publication
(10) Pub. No.: US 2004/0055440 A1
(43) Pub. Date: Mar. 25, 2004

(54) Device for influencing the sound of an upright piano

(76) Inventor: Ryoichi Totsuka, Dusseldorf (DE)

Correspondence Address: WILLIAM COLLARD, COLLARD & ROE, P.C., 1077 NORTHERN BOULEVARD, ROSLYN, NY, 11576, US

(21) Appl. No.: 10/415,892

(22) PCT Filed: Apr. 17, 2002
(86) PCT No.: PCT/EP02/04228

(30) Foreign Application Priority Data
Jul. 26, 2001 (DE) 101 37 509.3

(51) Int. Cl. G10C 3/02

(52) U.S. Cl. 84/182

(57) ABSTRACT

The invention relates to a device (2) for influencing the sound of an upright piano, comprising a housing (5) which is provided with at least one sound hole (7) on the side facing the keyboard of the piano. At least one plate-shaped sound deflector (11, 20, 21, 22) is provided inside the housing (5), adjacent to the sound hole (7), acting as an impediment to the sound waves in the direction of the sound hole (7) and extending the path of the sound waves in the direction of the sound hole (7). A warmer sound, especially for the base tones, can be obtained from the piano by extending the sound path in such a manner. Preferably, the inventive device is embodied as an add-on device which can be post-fitted to a piano.

### BACKGROUND OF THE INVENTION

1. Field of the Invention

The invention relates to a device for influencing the sound of an upright piano, comprising a housing which is provided with at least one sound hole on the side facing the keyboard of the piano.

2. Description of the Related Art

Such a device is known from German Patent Specification No. 140 895. In that known device, the sound hole is provided with a sound flap that is connected to the keyboard lid over an arrangement of joint rods in a way that it opens and closes together with the lid. Due to the interconnection via the arrangement of joint rods, however, the sound flap cannot be adjusted or closed independently of the keyboard lid.

From Patent Abstracts of Japan JP 09212155 A there is known a device for adjusting or amplifying, respectively, the sound of an upright piano. That device comprises a sound-insulating plate mounted to the piano-housing rear panel and providing an opening fitted with a closing mechanism. The closing mechanism comprises blind-tilting flaps that are interconnected by being pivoted with joints to a connecting rod. The connecting rod is adjustable from a control element, which is arranged at the front side of the piano below the keyboard, over a wire gearing. For this known sound/volume-controlling device to produce the optimum effect, the piano equipped with it should be placed in a way that its rear panel has a certain minimum distance to the closest room wall. Therefore, an upright piano equipped with this method has increased space requirements compared to conventional upright pianos.

Furthermore, in French Patent Application No. 2 520 536 there is described an upright piano comprising a self-supporting body accommodating the keyboard and the strings, and a multi-component casing. The casing components include, among other parts, two side panels and a top panel that all provide multiple flaps for sound amplification and sound deflection. The flaps provided on the side components of the casing increase the space requirements of the piano equipped with it, too.

### SUMMARY OF THE INVENTION

The object of the present invention is to create a device of the kind as described in the first paragraph of this application, providing for sound amplification and obtaining a warmer sound without increasing the space requirements of the piano.

This object is achieved according to the invention by a device having the features of claim 1. The device according to the invention essentially comprises a housing which is provided with at least one sound hole on the side facing the keyboard of the piano whereby at least one plate-shaped sound deflector is provided within the housing, adjacent to the sound hole, acting as an impediment to the sound waves in the direction of the sound hole and extending the path of the sound waves in the direction of the said sound hole.

The plate-shaped sound deflector may consist, for example, of a board acting as an impediment to the sound waves, extending the path of the sound waves and thus obtaining a warmer sound especially for the bass tones. It has proved to be particularly favorable when the sound deflector comprises multiple spaced deflector plates which are arranged in a way that they cause a meandering sound deflection in the direction of the said sound hole.

The invention provides a solution that does not increase the space requirements of the upright piano. The player experiences a particularly efficient sound amplification as he directly faces the sound hole. The sound hole can preferably be arranged at the player's face level.

The device according to the invention is particularly specific to small pianos with a height of 104 to 110 cm which only have a relatively small soundboard.

A preferred embodiment of the inventive device is that the sound hole can be opened and closed using a closing mechanism. The closing mechanism can comprise at least one flap which can be opened and closed in steps or continuously, whichever is more advantageous. The piano player can thus increase or decrease the perceivable sound strength of the piano respectively in steps or continuously.

According to another advantageous embodiment of the invention, the interior space of the housing is subdivided into multiple sections by at least one partition wall and/or multiple independently adjustable flaps whereby the flaps are associated with the same or different sound holes; the various sections are associated to strings of different pitches. This embodiment allows for performing pitch-specific sound influencing, for example, by amplifying only the bass sounds or the sounds of relatively high pitches by opening the independently adjustable covers. It is also possible to produce different sound deflections within the housing components subdivided by at least one partition wall.

According to an advantageous embodiment of the invention, the plate-shaped sound deflectors can also be implemented in a pivoting manner, so that they can be arranged not only in a parallel but also angular manner. This arrangement allows for forming a sound path that increases similar to a horn towards the sound outlet. Thus, the sound of the piano can be influenced or optimized to an even greater extent.

In particular, the inventive device can be embodied as an add-on device which can be post-fitted onto the top of the piano after opening or removing the lid on top of the piano housing. The inventive device thus allows a versatile sound manipulation with an already present upright piano. The inventive device, however, can also be installed into the housing of a newly built piano.

Additional preferred and advantageous embodiments of the invention are described in the subclaims.

### BRIEF DESCRIPTION OF THE DRAWINGS

The invention will be described in greater detail below based on schematic drawings that show several embodiments.

FIG. 1 is a perspective view of a piano fitted with the inventive device embodied as an add-on device;

FIG. 2 is a front view of the piano depicted in FIG. 1;

FIG. 3 is a cross-sectional view of the top part of the piano depicted in FIG. 1 in the area of the inventive device;

FIG. 4 is another cross-sectional view of the top part of the piano depicted in FIG. 1 in a front-wall area of the inventive device;

FIG. 5 is a perspective view of a piano fitted with the inventive device embodied as an add-on device according to a second form of embodiment; and

FIG. 6 is a cross-sectional view of the top part of the piano fitted with the inventive device embodied as an add-on device according to a third form of embodiment.

### DESCRIPTION OF THE PREFERRED EMBODIMENTS

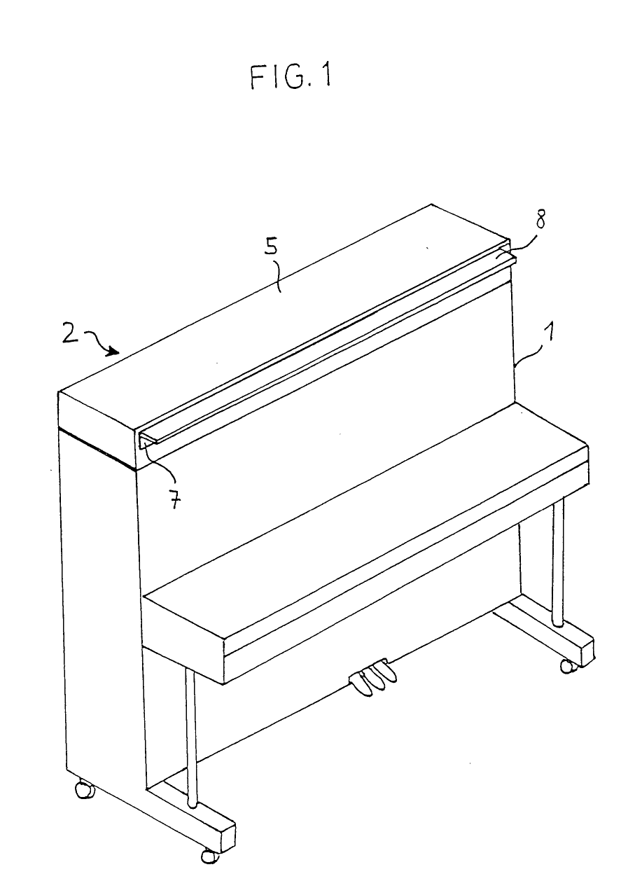

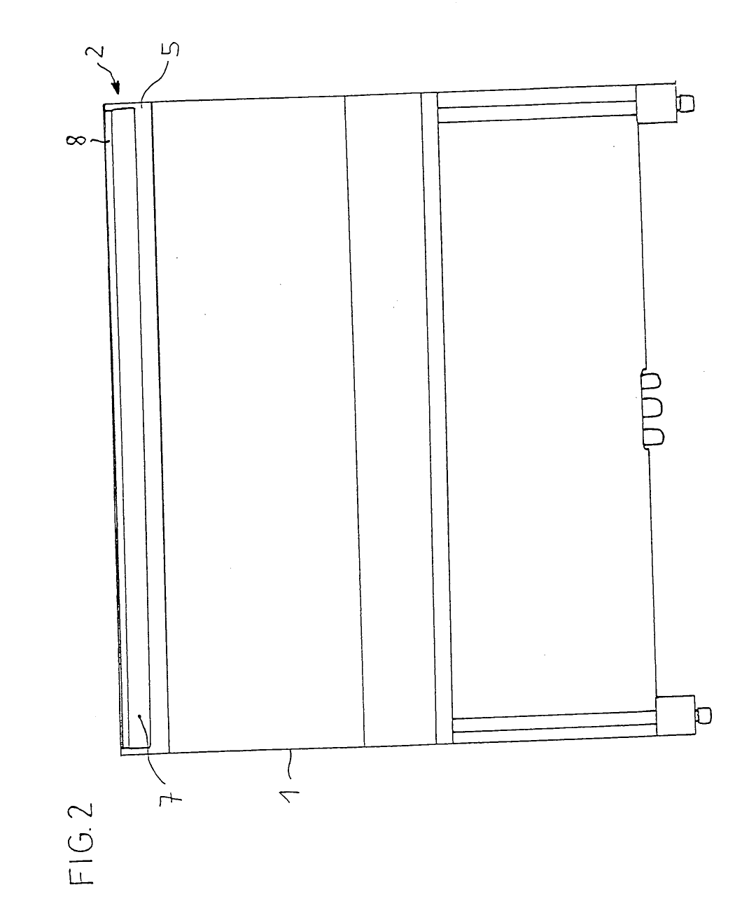

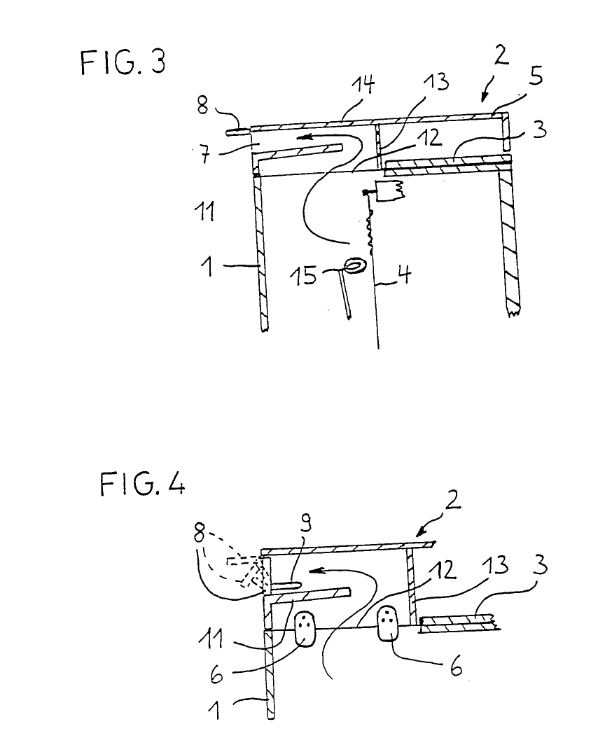

FIGS. 1 and 2 show an upright piano 1, that is, a piano with basically vertically arranged strings, on the top part of which an inventive device 2 is put on for influencing the sound of the piano 1. As usual, the top of the piano 1 is fitted with a hinged lid 3 which makes the mechanical system inside the piano 1 and the strings 4 wound onto a frame accessible for adjustment purposes (cf. FIGS. 3 and 4). When opening and pivoting or removing the lid 3, the inventive device 2 which in this wood or plastic material is put on the top of the piano 1. The width and depth of the housing 5 of the device 2 largely correspond tot he respective width and depth of the top part of the piano 1. As represented in FIG. 4, the inner panels of the front wall of the housing 5 of the device 2 bear connector elements 6 that fit into the open top part of the piano 1, thus producing a form-locked join of the device 2 with the piano 1.

The housing 5 provides a relatively small sound hole 7 on the side facing the keyboard of the piano 1. The sound hole 7 extends over almost the entire width of the piano 1 and can be opened and closed with a closing mechanism. In the depicted embodiment, the closing mechanism comprises a pivoting flap 8 that is fastened at the upper edge of the sound hole 7 with a strap hinge or suchlike. In addition, the flap 8 is fitted with a device 9 for continuous adjustment of various opening or pivoting positions at its ends. The dotted lines in FIG. 4 suggest two different opening positions.

As also represented in FIGS. 3 and 4, the housing 5 of the inventive device 2 comprises on the inside a plate-shaped sound deflector 11 which borders on the sound hole 7 located on the side facing the keyboard and partly covers the hole 12 arranged on the top panel of the piano 1. In the depicted embodiment, the plate-shaped sound deflector 11 is slightly tilted to the horizontal, slightly declining towards the sound hole 7. The housing 5 also comprises a basically vertically running wall 13 which borders on the rear edge of the hole 12 arranged on the top panel of the piano 1 and—in connection with another basically horizontally running wall 14 of the housing 5—defines a sound path wherein the plate-shaped sound deflector 11 forms an impediment that extends the way of the sound waves, which are generated by the keyboard-controlled felt-covered hammers 15 striking the strings 4, towards the sound hole 7. The extended way of the sound waves emitted from the oscillating strings 4 to the sound hole 7 is suggested by an arrow in the FIGS. 3 and 4. This sound deflection achieves a warmer sound and a longer tone; in particular, warmer bass sounds are achieved.

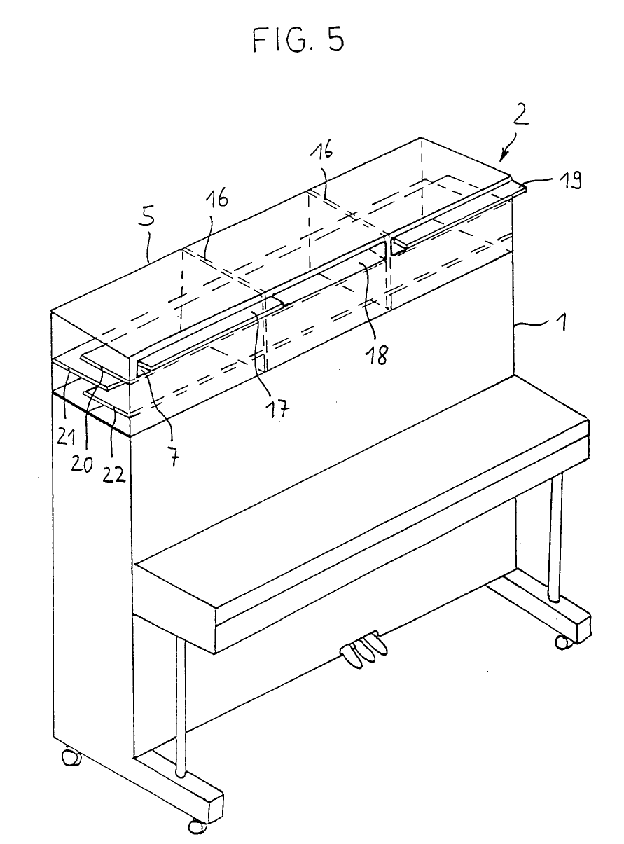

FIG. 5 depicts a second embodiment of the inventive device 2 for influencing the sound of the piano 1. The inside of the housing 5 of the device 2 is subdivided by partition walls 16 and independently operable flaps 17, 18, 19 into multiple sections associated with strings of different pitches. The flaps 17, 18, 19 are arranged at the same sound hole 7. FIG. 5 shows a setting where the center flap 18 is closed while the bass-section 17 and the treble-section flaps 19 are open.

There are several spaced deflector plates 20, 21, 22 within each of the individual sections of the housing 5, defining a meandering sound path in the respective section. The left front wall of the housing 5 is not depicted in FIG. 5 for reasons of clarity; thus, the offset deflector plates 20, 21, 22 are better to be seen.

It is within the scope of the invention to arrange more sound holes, which can be opened and closed with independently operable flaps, below the sound hole 7 depicted in FIG. 5. Such embodiment provides versatile adjustment options for influencing the sound of the piano 1 equipped with the inventive device. In addition, the deflector plates 20, 21, 22 can be mounted inside the housing 5 in a way that the space between them is adjustable. This provides another interesting possibility for influencing the sound of the said piano.

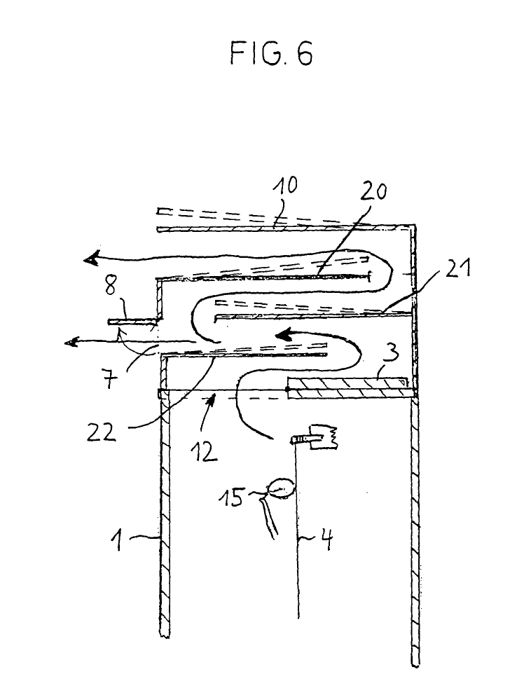

FIG. 6 depicts another embodiment of the inventive device 2. Again, the device 2 is arranged as an add-on device. It is put on the top part of the piano 1 after opening the lid 3 located on the top part of the piano 1. The housing 5 of the device 2 comprises on the inside three deflector plates 20, 21, 22, which are all fastened to a basically horizontal pivot. The adjustment options of the deflector plates 20, 21, 22 are suggested by the dash lines. The deflector plates 20, 21, 22 can independently be pivoted and fixed. The lower deflector plate 22 rises above the hole 12 present on the top part of the piano 1 towards the piano rear wall and ends at a certain distance from the piano rear wall. The center deflector plate 21 starts at the piano rear wall, exceeds the lower deflector panel 22, and ends at a certain distance from the piano front wall. Again, a sound hole 7 is arranged on the front panel of the device 2 which can be opened and closed with a flap 8 pivoted at the upper edge of the sound hole 7.

The lower deflector plate 22, the rear wall of the housing 5, and the center deflector plate 21 define a sound path. This sound path is followed by an extension which is defined by the center deflector plate 21, the front wall of the housing 5, the upper deflector plate 20, the rear wall of the housing 5, and the upper housing wall 10 which in this example is pivoted, too. It is obvious that the upper deflector plate 20 exceeds the lower deflector plate 22 towards the rear wall of the housing 5 and ends at a certain distance from the piano rear wall. No flap is arranged at the sound outlet formed by the upper deflector plate 20 and the upper housing wall 10. The adjustment of the inclination angles of the deflector plates 20, 21, 22 and the upper housing wall 10 allows for influencing or optimizing, respectively, the sound of the respective piano 1. In particular, a hornlike increasing sound path can be set up.

If the flap 8 is tilted to the opening position depicted in FIG. 6, the sound originating from the strings 4 stroke by the hammers 15 passes through the sound path and is largely output from the sound hole 7. If, however, the sound hole 7 is closed by the flap 8, the sound originating from the strings 4 passes through the sound path and is largely output from the upper sound hole.

It is to be understood that the invention is not limited to the embodiments set forth above. Rather, the invention is capable of other embodiments and of being practiced and carried out in various ways basing on the inventive idea defined in the attached claims.

1. A device for influencing the sound of an upright piano comprising a housing which is provided with at least one sound hole on the side facing the keyboard of the piano, wherein at least one plate-shaped sound deflector (11, 20, 21, 22) is arranged in the interior space of the housing (5), wherein said deflector borders to the sound hole (7) and forms an impediment to the sound waves in the direction of the sound hole (7), and thereby extending the way of the sound waves in the direction of the sound hole (7).

2. The device according to claim 1, wherein the sound hole (7) can be opened and closed using a closing mechanism.

3. The device according to claim 2, wherein the closing mechanism comprises at least one flap (8, 17, 18, 19) which can be opened and closed in steps or continuously.

4. The device according to one of claims 1 to 3, wherein the sound deflector comprises several spaced deflector plates (20, 21, 22) which are arranged in a way that they produce a meandering sound deflection in the direction of the sound hole (7).

5. The device according to claim 4, wherein the distance between the deflector plates (20, 21, 22) is adjustable.

6. The device according to one of claims 1 to 5, wherein the inside of the housing (5) is subdivided by at least one partition wall (16) and/or multiple independently operable flaps (17, 18, 19) into multiple sections associated with strings of different pitches, wherein the flaps (17, 18, 19) are arranged at the same or different sound holes.

7. The device according to one of claims 1 to 6, wherein at least one plate-shaped sound deflector (20, 21, 22) is designed such that it can be pivoted around a basically horizontal axis of rotation.

8. The device according to one of claims 1 to 7, wherein the housing (5) of the device (2) is arranged as an add-on device to be arranged on an upright piano (1).

9. The device according to one of claims 1 to 7, wherein the housing (5) of the device (2) is integrated into the housing of the piano (1).
